(19) United States
(12) Patent Application Publication
(10) Pub. No.: US 2005/0018081 A1
(43) Pub. Date: Jan. 27, 2005

(54) Disc player integration type television receiver

(75) Inventor: Akihiko Tomikawa, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/868,028

(22) Filed: Jun. 16, 2004

(30) Foreign Application Priority Data
Jun. 17, 2003 (JP) P2003-172111

(51) Int. Cl. H04N 5/268; H04N 11/00

(52) U.S. Cl. 348/552; 348/836; 348/705

(57) ABSTRACT

A disc player integration type television receiver in which a disc player that reproduces data from any one of a DVD on which images are recorded and a CD on which sounds are recorded and a television receiver equipped with a CRT that displays the images of the DVD on the basis of a signal reproduced by the disc player and a speaker that outputs the sounds of the CD is integrated. During a period of time from such time that the DVD or the CD is loaded on the disc player until such time that the television receiver receives a reproduction signal of a loaded disc, an image of television broadcasting which is received by an antenna is displayed on the CRT.

### BACKGROUND OF THE INVENTION

1. Field of the Invention

This invention relates to a disc player integration type television receiver in which a disc player which reproduces data from anyone of an image disc and a sound disc, and a television receiver, are integrated.

2. Description of the Related Art

Among television receivers, there is a disc player integration type television receiver which is integrated with a disc player that reads out and reproduces data from any one of an image disc on which images are recorded such as a DVD and a sound disc on which sounds are recorded such as an audio CD. FIG. 5 is a block diagram that shows an electric configuration of a conventional disc player integration type television receiver. In FIG. 5, 50 designates a disc player integration type television receiver (hereinafter, described as integration type receiver), and is composed of a television receiver (hereinafter, described as TV) 51, and a disc player (hereinafter, described as player) 52 which reproduces data recorded on a DVD 20 or a CD 30. In the TV 51, 53 designates an antenna which receives television broadcasting electromagnetic waves, and 54 designates a tuner which extracts a television broadcasting signal of a desired channel from the television broadcasting electromagnetic waves received by the antenna 53. 55 designates a signal processing part and processes a television broadcasting signal which is outputted from the tuner 54, CD fixed image data which will be described later, and a reproduction signal of the DVD 20 or the CD 30, which is being transmitted from the player 52 and will be described later and a fixed image signal for lead, and outputs a sound signal and an image signal. In addition, as the image signal which is outputted by the signal processing part 55, there are a television broadcasting image signal, a CD fixed image signal, a fixed image signal for lead, and a DVD image signal, but from the signal processing part 55, 1 image signal of the above-described 4 image signals is outputted.

56 designates a sound amplifier which amplifies a sound signal from the signal processing part 55, and 57 designates a speaker which outputs a sound and 58 designates a CRT (Cathode Ray Tune) which displays an image, and 59 designates a CRT drive part which drives the CRT 58 on the basis of an image signal from the signal processing part 55. 63 designates a microcomputer which controls each part of the TV 51, and 64 designates a memory which is composed of an EEPROM, etc., in which a fixed image for CD was stored. Here, the fixed image for CD means a fixed image unchanged, which is displayed on the CRT 58 when a sound recorded in the CD 30 is outputted from the speaker 57, and in this example, a blue screen of an entire blue surface is displayed. In addition, if this fixed image is not displayed, it is turned to a no image signal state, since an image is not recorded on the CD 30, and a noise screen (sandstorm screen) is to be displayed on the CRT 58. In this manner, to display a fixed image in such a stage that there is no image signal is generally carried out, in not only a disc player integration type television receiver but also a VCR integration type television receiver as described in JP-A-11-177895. 65 designates an operation part, and is composed of a power switch, a channel selection button, a button for in and out of a tray on which the DVD 20 or the CD 30 is loaded, and so on.

In the player 52, 66 designates a disc reading part which reads data from the DVD 20 or the CD 30 which was loaded on the player 52, and is composed of a pickup, a spindle motor, a servo circuit, and so on. 67 designates a signal processing part, and processes and reproduces data which was read by the disc reading part 66, and transmits the reproduced signal to the signal processing part 55 of the TV 51. Also, the signal processing part 67 processes data of a fixed image for lead which will be described later, and transmits the processed signal to the signal processing part 55. 68 designates a microcomputer which controls each part of the player 52, and 69 designates a memory which is composed of an EEPROM etc. in which a fixed image for lead was stored. Here, the fixed image for lead means a fixed image unchanged, which is displayed on the CRT 58 during a period from such time that the DVD 20 or the CD 30 was loaded on the player 52 until such time that a signal, which was obtained by reading and reproducing data of the loaded disc, is transmitted to the signal processing part 55, and in this example, a black screen of an entire black surface is displayed. In addition, if this fixed image is not displayed it is turned to a no image signal state, and a noise screen (sandstorm screen) is to be displayed on the CRT 58.

P1 designates a control signal transmitting and receiving port for transmitting and receiving a control signal between the microcomputer 63 and the microcomputer 68, and P2 designates a disc information transmission port for informing a type of a disc which was loaded on the player 52 from the microcomputer 68 to the microcomputer 63. P3 designates a DVD reproduction signal transmission port for transmitting a reproduction signal of the DVD 20 from the signal processing part 67 to the signal processing part 55, and P5 designates a fixed image signal transmission port for transmitting a fixed image signal for lead from the signal processing part to the signal processing part 55.

The operation of the above-described conventional integration type receiver 50 will be described. When it is detected by a sensor, etc., that the DVD 20 or the CD 30 was loaded on the player 52, the microcomputer 68 reads out fixed image data for lead from the memory 69 and sends it to the signal processing part 67, and the signal processing part 67, which received this data, processes the data, and thereafter, transmits a signal of the fixed image for lead to the signal processing part 55 of the TV 51 through the fixed image transmission port PS. The signal processing part 55, when it receives the fixed image signal for lead, processes this to output, and the CRT drive part 59, which received this output, drives the CRT 58, so that a black screen, which is the fixed image for lead, is displayed on the CRT 58. As described above, during such a period that the fixed image for lead is displayed, the microcomputer 68 reads TOC (Table Of Contents) information from the loaded disc by the disc reading part 66, and on the basis of this TOC information, judges whether a disc is the DVD 20 on which images are recorded, or the CD on which images are not recorded and sounds are recorded. And, it informs a result of that judgment to the microcomputer 63 through the disc information transmission port P2. In addition, among disc players, as described in JP-A-1-294276, there is a type which judges whether a disc is a CD-ROM or a CD, in accordance with whether a synchronization signal, which synchronizes a servo circuit, etc., is recorded in a disc or not. Also, in the VCR integration type television receiver of JP-A-11-177895, a judgment of whether an image is recorded in a recording medium or not is carried out at the TV side but not at the player side, on the basis of a voltage level of a synchronization signal which is generated by a synchronization circuit for displaying an image on a CRT.

When it informs a type of a disc, the microcomputer 68 reads out data of an image or a sound from a disc by the disc reading part 66, and sends it to the signal processing part 67. The signal processing part 67 processes data of the disc, which has been transmitted, and reproduces it, and if a reproduced signal is a reproduction signal of the DVD 20, transmits it to the signal processing part 55 through a DVD reproduction signal transmission port P3, and if a reproduced signal is a reproduction signal of the CD 30, transmits it to the signal processing part 55 through a CD reproduction signal transmission port P4. Here, in case that the transmitted reproduction signal is a reproduction signal of the DVD 20, the signal processing part 55 receives the reproduction signal of the DVD 20 and processes this, and outputs an image signal and a sound signal. And, the CRT drive part 59, which received the image signal, drives the CRT 58 on the basis of this signal, and an image of the DVD 20 is displayed on the CRT 58, being switched from the black screen, At the same time of this, the sound amplifier 56, which received the sound signal, amplifies this, and a sound of the DVD 20 is outputted from the speaker 57.

On one hand, in case that a reproduction signal transmitted from the signal processing part 67 is a reproduction signal of the CD 30, the microcomputer 63, since it has already received from the microcomputer 68 such a notice that the loaded disc is the CD on which images are not recorded as described above, reads out fixed image data for CD from the memory 64, and sends it to the signal processing part 55. And, the signal processing part 55 receives the fixed image data for CD and processes it, and outputs a fixed image signal for CD, and receives a reproduction signal of the CD and processes it, and outputs a sound signal. After this, the CRT drive part 59, which received the fixed image signal for CD, drives the CRT 58 on the basis of it, and the blue screen, which is the fixed image for CD, is displayed on the CRT 58, being switched from the black screen, and at the same time of this, the sound amplifier 56, which received the sound signal, amplifies this, and a sound of the CD 30 is outputted form the speaker 57.

### SUMMARY OF THE INVENTION

As described above, in the conventional integration type receiver 50, during a period from such time that the DVD 20 or the CD 30 is loaded on the player until such time that the signal processing part 55 receives a reproduction signal of a loaded disc, the black screen (fixed image for lead) is displayed on the CRT 58, instead of a noise screen. However, since an amount of time for that period is approximately 10 to 12 seconds, there is such a problem that, when the unchanged black screen is displayed continuously on the CRT 58 for approximately 10 to 12 seconds, a user feels that waiting time until information of a disc can be viewed and heard is very long, and becomes uncomfortable.

This invention is made to solve the above-described problem, and an object of the invention is to provide a disc player integration type television receiver which does not have a user feel that waiting time until information of a disc can be viewed and heard is long.

In this invention, in a disc player integration type television receiver, in which a disc player that reproduces data from any one of an image disc on which images are recorded and a sound disc on which sounds are recorded and a television receiver equipped with display means that displays the images of the image disc on the basis of a signal which is reproduced by the disc player and sound output means that outputs the sounds of the sound disc, are integrated, the television receiver displays an image of television broadcasting received by an antenna on the display means during a period from such time that the image disc or the sound disc is loaded on the disc player until such time that a reproduction signal of a loaded disc is received.

In this manner, if an image of television broadcasting is displayed, during a period from such time that the image disc or the sound disc is loaded on the disc player until such time that a reproduction signal of a loaded disc is received, since an image of television broadcasting changes momentarily, by having users view and hear television broadcasting, it is possible not to have them feel that waiting time until information of a disc can be viewed and heard is long. Also, since it eliminates such need that fixed image data for reading is processed at a disc player side and transmitted to a television receiver as in the prior art, it is possible to ease a burden of the player by reducing processes to be carried out by the disc player, and it is also possible to eliminate the fixed image transmission port P5 as shown in FIG. 5 and the fixed image data for reading itself, so that it becomes possible to keep cost low on an entire integration type receiver.

Also, in this invention, a television receiver is provided with storage means in which a fixed images, which does not change, is stored, switching means which switches over so as to display any one of images of television broadcasting, the fixed image and images of the image disc, on the display means, and control means which controls the switching means. In this configuration, the control means switches over the switching means to display the images of television broadcasting, when an image disc or a sound disc is loaded on a disc player. And, after this, the control means judges which one of a reproduction signal of the image disc and a reproduction signal of the sound disc is received, and if it judges that the reproduction signal of the image disc is received, switches over the switching means to display the images of the image disc on the display means, and if it judges that the reproduction signal of the sound disc is received, switches over the switching means to display the fixed images on the display means.

In this manner, when it is judged that a reproduction signal of the image disc or the sound disc is received, if an image of television broadcasting, which is displayed on the display means, is switched to an image of the image disc or a fixed image of a memory, it is possible to have users recognized promptly that information of a disc can be viewed and heard, and to have them enjoy an image and a sound of the disc after that. Also, when it is judged that a reproduction signal of a disc is a reproduction signal of the image disc or a reproduction signal of the sound disc at the television receiver side, i.e., when it is judged that a loaded disc is the image disc or the sound disc, since it eliminates such need that a judgment of a disc is carried out at a disc player side and its result is informed to a television receiver side as in the prior art, it is possible to ease a burden of the player more, by reducing processes to be carried out by the disc player, and it is possible to eliminate the disc information transmission port P2 as shown in FIG. 5, so that it becomes possible to keep cost further low on al entire integration type receiver.

Also, in this invention, in addition to the above-described configuration, a television receiver is provided with a first synchronization circuit which generates a synchronization signal for displaying images of television broadcasting or fixed images on display means, and a second synchronization circuit which generates a synchronization signal for displaying images of the image disc on the display means. In this configuration, control means judges whether a frequency of a synchronization signal, which is generated by the second synchronization circuit, coincides with a predetermined value or not, and if it coincides with the predetermined value, judges that a reproduction signal of the image disc is received, and if it does not coincide with the predetermined value, judges that a reproduction signal of the sound disc is received.

In this manner, when the second synchronization circuit is disposed separately from the first synchronization circuit, if the television receiver receives a reproduction signal of the image disc during such a period that images of television broadcasting are displayed on the display means, an image signal of the image disc is inputted in the second synchronization circuit, and a frequency of a synchronization signal of the second synchronization circuit coincides with the predetermined value, and it can be easily judged that a reproduction signal of the image disc is received. Also, if the television receiver does not receive a reproduction signal of the image disc, since an image signal of the image disc is not inputted in the second synchronization circuit, and the frequency of the synchronization signal of the second synchronization circuit does not coincide with the predetermined value, it can be easily judged that a reproduction signal of the image disc is not received, but a reproduction signal of the sound disc is received. In addition, as in the prior art shown in FIG. 5, by providing two ports P3, P4 of the reproduction signal transmission port P3 which is used exclusively for an image disc, and the reproduction signal transmission port P4 which is used exclusively for a sound disc and detecting presence or absence of transmission of a signal from respective ports P3, P4, it is also possible to judge whether a reproduction signal of the image disc is received, or a reproduction signal of the sound disc is received at a television receiver side, but when the second synchronization circuit is disposed to judge a reproduction signal of a disc as described above, it eliminates such need that ports for transmitting a reproduction signal of the image disc and a reproduction signal of the sound disc are provided separately, and therefore, it becomes possible to keep cost further low on an entire integration type receiver, by reducing the number of ports between a disc player and a television receiver.

Furthermore, in a disc player integration type television receiver in a typical embodiment of this invention, a disc player which reproduces data from any one of a DVD on which images were recorded and a CD on which sounds were recorded, and a television receiver, which is equipped with a CRT which displays images of the DVD on the basis of a signal which is reproduced by the disc player and a speaker which outputs a sound of the CD, are integrated. And the television receiver is equipped with a memory in which fixed images, which do not change, were stored, a first synchronization circuit which generates a synchronization signal for displaying images of television broadcasting, which were received by an antenna or the fixed images, on the CRT, a second synchronization circuit which generates a synchronization signal for displaying images of the DVD, on the CRT, a switch which switches over so as to display any one of the images of television broadcasting, the fixed images and the images of the DVD, on the CRT, and a microcomputer which controls the switch. In the above-described configuration, the microcomputer switches over the switch to display the images of television broadcasting, when a DVD or a CD is loaded on the disc player. And, after this, the microcomputer judges whether a frequency of a horizontal synchronization signal, which is generated by the second synchronization circuit, coincides with a predetermined value or not, and if it coincides with the predetermined value, judges that a reproduction signal of the DVD is received, and switches over the switch to display the images of the DVD on the CRT, and if it does not coincide with the predetermined value, judges that a reproduction signal of the CD is received, and switches over the switch to display the fixed images on the CRT.

In an integration type receiver on which a disc player, which is capable of reproducing a DVD or a CD, is mounted, waiting time from such time that a disc is loaded on the disc player until such time that information of a disc can be viewed and heard is long, like approximately 10 to 12 seconds, and therefore, to apply this invention to an integration type receiver on which a disc player is mounted as described above is of very great significance.

### BRIEF DESCRIPTION OF THE DRAWINGS

FIG. 1 is a block diagram of a disc player integration type television receiver according to an embodiment of this invention;

FIG. 2 is a view showing a detailed configuration of an image signal switching part;

FIG. 3 is a flow chart of the disc player integration type television receiver;

FIG. 4 is a view showing a detailed configuration of an image signal switching part of another embodiment; and

FIG. 5 is a block diagram of a conventional disc player integration type television receiver.

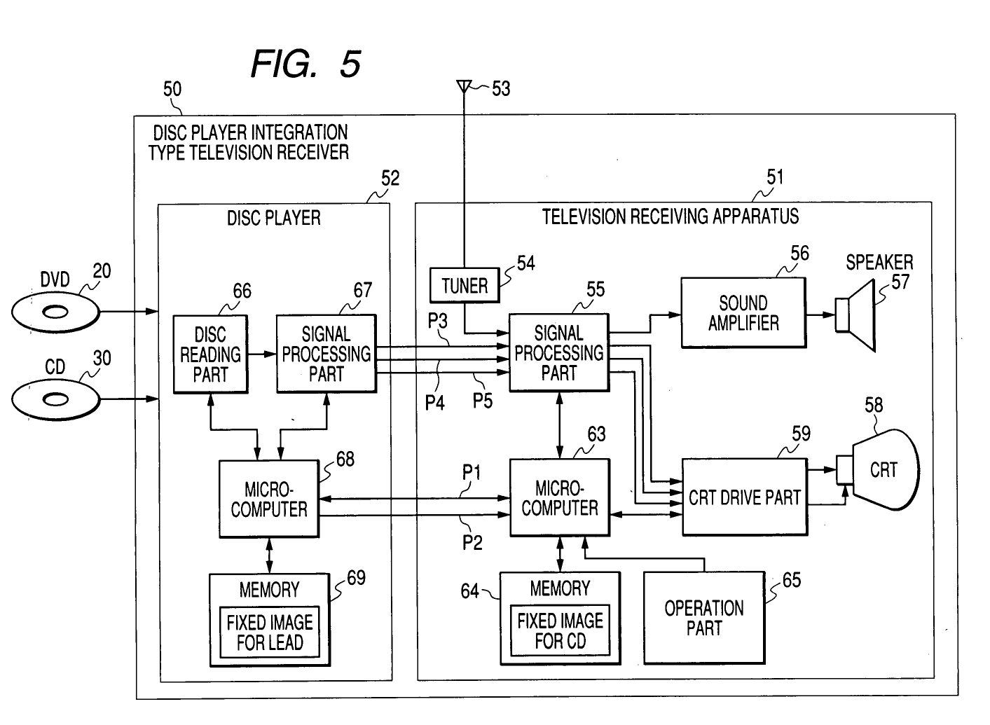

### DETAILED DESCRIPTION OF THE PREFFERED EMBODIMENTS

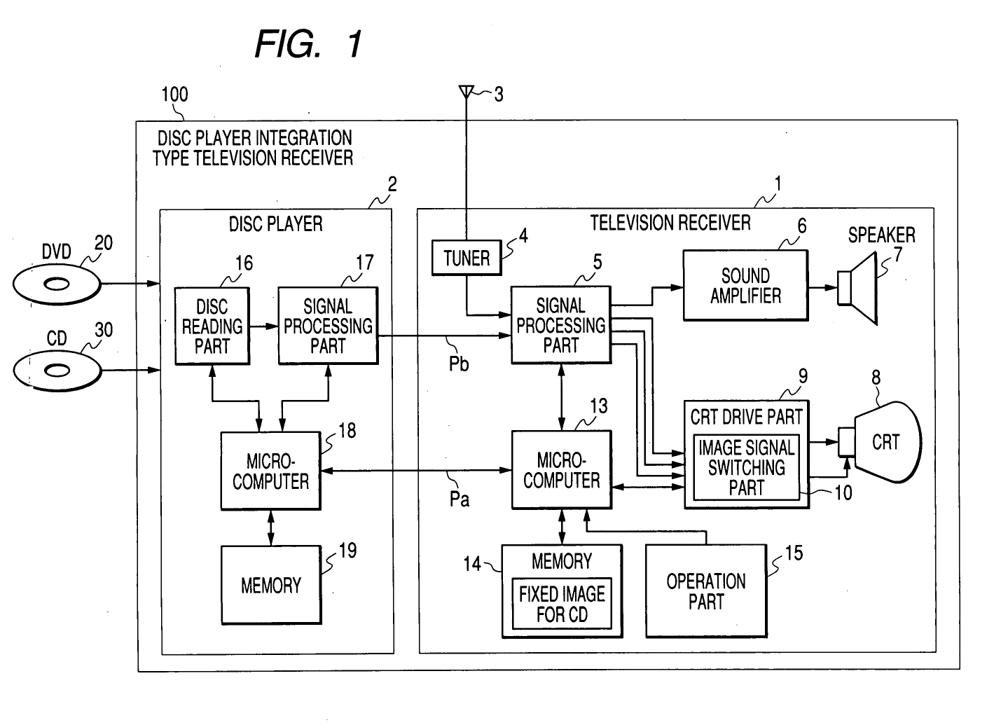

FIG. 1 is a block diagram showing an electric configuration of a disc player integration type television receiver according to one embodiment of this invention. In FIG. 1, 100 designates a disc player integration type television receiver (hereinafter, described as integration type receiver) and includes a television receiver (hereinafter, described as TV) 1, and a disc player (hereinafter, described as player) 2 which reproduces data which was recorded on DVD 20 or CD 30. In the TV 1, 3 designates an antenna which receives television broadcasting electromagnetic waves, and 4 designates a tuner which extracts a television broadcasting signal of a desired channel from the television broadcasting electromagnetic waves received by the antenna 3. 5 designates a signal processing part and processes a television broadcasting signal which is outputted from the tuner 4, CD fixed image data which will be described later, and a reproduction signal of the DVD 20 or the CD 30, which is being transmitted from the player 2 and will be described later, to output a sound signal and an image signal.

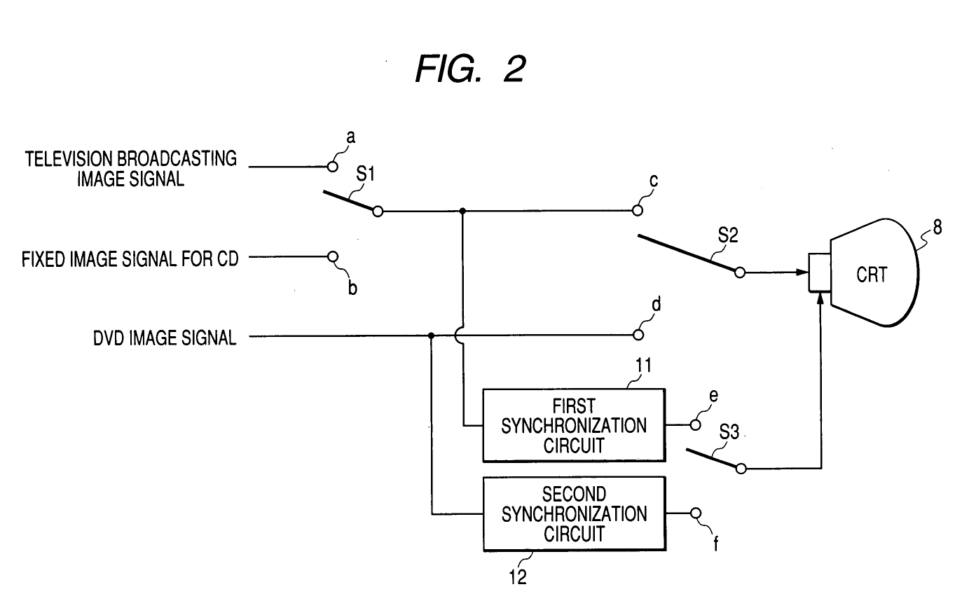

6 designates a sound amplifier which amplifies a sound signal from the signal processing part 5, and 7 designates a speaker which outputs a sound, and 8 designates a CRT (Cathode Ray Tune) which displays an image, and 9 designates a CRT drive part which drives the CRT 8 on the basis of an image signal from the signal processing part 5, and 10 designates an image signal switching part which is disposed in the CRT drive part 9. Detail of the image signal switching part 10 will be described in FIG. 2. 13 designates a microcomputer which controls each part of the TV 1, and 14 designates a memory which is composed of an EEPROM, etc., in which a fixed image for CD was stored. Here, the fixed image for CD means a fixed image unchanged, which is displayed on the CRT 8 when a sound recorded in the CD 30 is outputted from the speaker 7, and in this example, a blue screen of an entire blue surface is displayed. Other than the blue screen, a still image screen including a character and a drawing may be displayed. By displaying the suchlike fixed image, it is possible to prevent a noise screen (sandstorm screen) on the CRT 8, when it is turned to a no image signal state due to such fact that an image is not recorded in the CD S0, at the time of outputting a sound of the CD 30. 15 designates an operation part, and is composed of a power switch, a channel selection button, a button for in and out of a tray on which the DVD 20 or the CD 30 is loaded, and so on.

In the player 2, 16 designates a disc reading part which reads data from the DVD 20 or the CD 30 which was loaded on the player 2, and is composed of a pickup, a spindle motor, a servo circuit, and so on. 17 designates a signal processing part, and processes and reproduces data which was read by the disc reading part 16, and transmits the reproduced signal to the signal processing part 5 of the TV 1. 18 designates a microcomputer which controls each part of the player 2, and 19 designates a memory which is composed of an EEPROM, etc. Pa designates a control signal transmission and reception port for transmitting and receiving a control signal between the microcomputer 13 and the microcomputer 18, and Pb designates a reproduction signal transmission port for transmitting a reproduction signal of the DVD 20 or a reproduction signal of the CD 30 from the signal processing part 17 to the signal processing part 5.

In the above-described configuration, the DVD 20 configures an image disc in this invention, and the CD 20 configures a sound disc in this invention. The speaker 7 configures sound output means. in this invention, and the CRT 8 configures display means in this invention. The microcomputer 13 configures control means in this invention, and the memory 14 configures storage means in this invention, and the fixed image for CD, which is stored in the memory 14, configures a fixed image in this invention.

FIG. 2 is a view showing a detailed configuration of the above-described image signal switching part 10. In FIG. 2, to the image signal switching part 10, inputted are such a television broadcasting image signal that a television broadcasting signal was processed from the signal processing part 5, such a fixed image signal for CD that a fixed image for CD was processed, and such a DVD image signal that a reproduction signal of the DVD 20 was processed, respectively. 11 designates a first synchronization circuit which generates a synchronization signal for displaying an image of television broadcasting or a fixed image for CD on the CRT 8, and 12 designates a second synchronization circuit which generates a synchronization signal for displaying an image of the DVD 20 on the CRT 9. When an image signal is inputted, frequencies of horizontal synchronization signals which are generated by the synchronization circuits 11, 12 coincide with 15.73 KHz, and frequencies of vertical synchronization signals coincide with 60 Hz. In addition, the microcomputer 13 of FIG. 1 judges whether a frequency of a horizontal synchronization signal which is generated by the second synchronization circuit 12 coincides with 15.73 KHz or not, as described later. S1 to S3 designate switches which are switched for displaying any one of an image of television broadcasting, a fixed image for CD, and an image of the DVD 20, on the CRT 8.

In case that a television broadcasting image signal was inputted from a state of FIG. 2, if the switch S1 is connected to a contact point a, and the switch S2 is connected to a contact point c, and the switch S3 is connected to a contact point e, the television broadcasting image signal is inputted to the CRT 8 by the CRT drive part 9 of FIG. 1, and inputted to the first synchronization circuit 11, and a synchronization signal is generated in the first synchronization circuit 11, on the basis of the television broadcasting image signal, and that synchronization signal is inputted to the CRT 8 by the CRT drive part 9. By this, an image of television broadcasting is displayed on the CRT 8. Also, in case that a fixed image signal for CD was inputted, if the switch S1 is connected to a contact point b, and the switch S2 is connected to the contact point c, and the switch S3 is connected to the contact point e, a fixed image signal for CD is inputted to the CRT 8 by the CRT drive part 9, and inputted to the first synchronization circuit 11, and a synchronization signal is generated in the first synchronization circuit 11, on the basis of the fixed image signal for CD, and that synchronization signal is inputted to the CRT 8 by the CRT drive part 9. By this, a blue screen, which is a fixed image for CD, is displayed on the CRT 8. In contrast to the foregoing, in case that a DVD image signal was inputted, the DVD image signal is inputted to the second synchronization circuit 12, and a synchronization signal is generated in the second synchronization circuit 12, on the basis of the DVD image signal. At this time, if the switch S2 is connected to a contact point d, and the switch S3 is connected to a contact point f, the DVD image signal is inputted to the CRT 8 by the CRT drive part 9, and the synchronization signal, which was generated by the second synchronization circuit 12, is inputted to the CRT 8 by the CRT drive part 9. By this, an image of the DVD 20 is displayed on the CRT 8.

In the above-described configuration, the switches S1 to S3 configure switching means in this invention, and the first synchronization circuit 11 configures a first synchronization circuit in this invention, and the second synchronization circuit 12 configures a second synchronization circuit in this invention.

Then, an operation of the above-described integration type receiving apparatus 100 will be described. In FIG. 1, when it is detected by a sensor etc. that the DVD 20 or the CD 30 was loaded on the player 2, the microcomputer 18 of the player 2 notifies this to the microcomputer 13 of the TV 1 through the control signal transmission and reception port Pa. The microcomputer 13, which received this notice, has the signal processing part 5 processed a television broadcasting signal which was obtained by the antenna 3 and the tuner 4, to output an image signal and a sound signal of television broadcasting, respectively. By this, a television broadcasting image signal is inputted to the image signal switching part 10, and a television broadcasting sound signal is inputted to the sound amplifier 6. Successively, the microcomputer 13 connects the switch S1 of FIG. 2 to the contact point a, and connects the switch S2 to the contact point c, and connects the switch S3 to the contact point e, and inputs the television broadcasting image signal to the CRT 8 by the CRT drive part 9 (FIG. 1), and a synchronization signal, which was generated by the first synchronization circuit 11, to the CRT B by the CRT drive part 9. By this, an image of television broadcasting is displayed on the CRT S. Also, at this time, simultaneously, the television broadcasting sound signal, which was inputted to the sound amplifier 6, is amplified here, and a sound of television broadcasting is outputted from the speaker 7.

As described above, during such a period that the image of television broadcasting is displayed on the CRT 8, and the sound is outputted from the speaker, the microcomputer 18 of the player 2 reads data of a loaded disc by the disc reading part 16, and transmits it to the signal processing part 17. The signal processing part 17 processes and reproduces the transmitted data of the disc, and transmits a reproduced signal to the signal processing part 5 through the reproduction signal transmission port Pb. Here, in case that a transmitted reproduction signal is a reproduction signal of the DVD 20, the signal processing part 5 receives a reproduction signal of the DVD 20 and processes this, to output an image signal and a sound signal. By this, the image signal is inputted to the image signal switching part 10, and the sound signal is inputted to the sound amplifier 6. And, when the DVD image signal is inputted to the image signal switching part 10, the DVD image signal is inputted to the second synchronization circuit 12 as described above, and a synchronization signal is generated by the second synchronization circuit 12. At this time, a frequency of a horizontal synchronization signal, which was generated by the second synchronization circuit 12, coincides with 15.73 KHz, and therefore, the microcomputer 13 detects this, and judges that a reproduction signal of the DVD 20 was received from the player 2 side. And, the microcomputer 13 connects the switch S2 to the contact point d, and connects the switch S3 to the contact point f, and inputs the DVD image signal to the CRT 8 by the CRT drive part 9 as described above, and inputs a synchronization signal, which was generated by the second synchronization circuit 12, to the CRT 8 by the CRT drive part 9. By this, an image of the DVD 20 is displayed on the CRT 8, instead of an image of television broadcasting. Also, at this time, simultaneously, the sound signal, which was inputted to the sound amplifier, is amplified here, and a sound of the DVD 20 is outputted from the speaker 7.

On one hand, in case that a reproduction signal, which was transmitted from the signal processing part, is a reproduction signal of the CD 30, the signal processing part 5 receives a reproduction signal of the CD 30 and processes this, to output a CD sound signal. By this, the CD sound signal is inputted to the sound amplifier 6. At this time, a frequency of a horizontal synchronization signal, which is generated by the second synchronization circuit 12, does not coincides with 15,73 KHz, and therefore, the microcomputer 13 detects this, and judges that a reproduction signal of the CD 30, but not a reproduction signal of the DVD 20, was received from the player 2 side. And, the microcomputer 13 connects the switch S1 to the contact point b, and connects the switch S2 to the contact point c, and connects the switch S3 to the contact point e, and inputs the fixed image signal for CD, to the CRT 8 by the CRT drive part 9 as described above, and inputs a synchronization signal, which was generated by the first synchronization circuit 11, to the CRT 8 by the CRT drive part 9. By this, a blue screen, which is the fixed image for CD, is displayed on the CRT 8, instead of an image of television broadcasting. Also, at this time, simultaneously, the CD sound signal, which was inputted to the sound amplifier, is amplified here, and a sound of the CD 30 is outputted from the speaker 7.

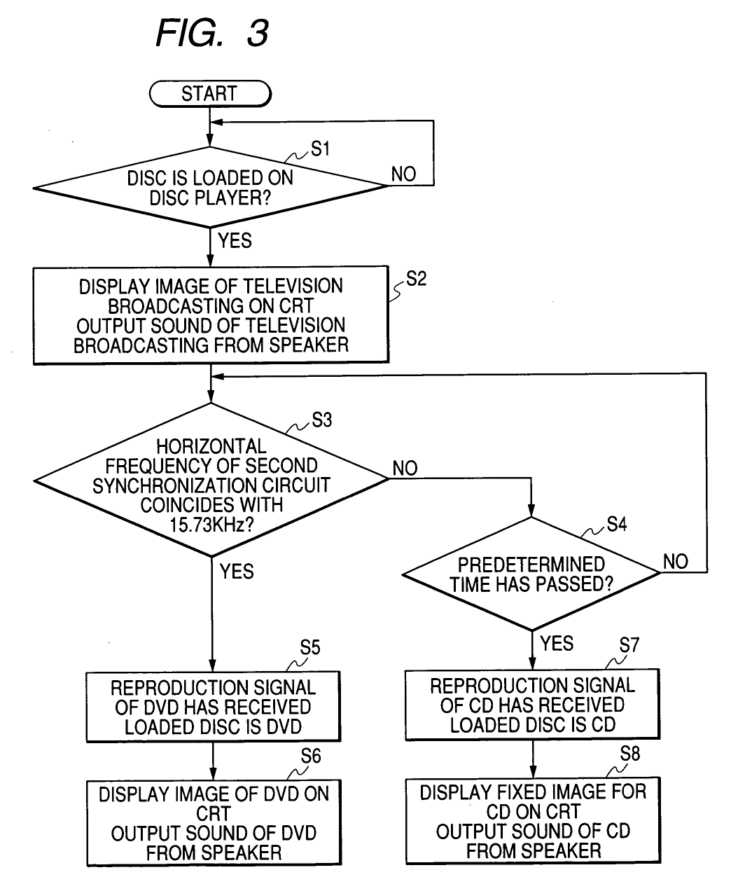

FIG. 3 is a flow chart showing an operating procedure of the integration type receiving apparatus. In addition, each process is carried out by the microcomputer 13 of the TV 1. In FIG. 3, when the DVD 20 or the CD 30 is loaded on the player 2, since the microcomputer 18 of the player 2 notifies this (step S1: YES), the microcomputer 13 has the signal processing part 5 processed a television broadcasting signal which was obtained by the antenna 3 and the tuner 4, and thereafter, switches over the switches S1˜S3 of the image signal switching part 10 as described above, and displays an image of television broadcasting on the CRT 8, on the basis of a television broadcasting image signal from the signal processing part 5, and outputs a sound of television broadcasting from the speaker 7, on the basis of a television broadcasting sound signal from the signal processing part 5 (step S2).

After this, it detects a frequency of a horizontal synchronization signal which is generated by the second synchronization circuit 12, and judges whether this frequency coincides with 15.73 Kz or not (step S3). Here, if the frequency of the horizontal synchronization signal of the second synchronization circuit 12 does riot coincide with 15.73 KHz (step S3: NO), it judges whether predetermined time has passed or not from such time that a disc was loaded on the player 2 (step S4). In addition, elapsed time from such time a disc was loaded on the player 2 is measured by use of a predetermined area of a memory with which the microcomputer 13 is equipped internally. Also, the above-described predetermined time is, for example, approximately 10˜12 seconds, and is preferably set up in such a manner that it is longer than a period of necessary time from such time that the player 2 reads and reproduces data of the DVD 20 or the CD 30 until such time a reproduced signal thereof is received by the signal processing part 5 of the TV 1. If the predetermined time has not yet passed in the step S4 (step is S4: NO), a routine is shifted to the step S3, and it judges again whether the frequency of the horizontal synchronization signal of the second synchronization circuit 12 coincides with 15.73 KHz or not, and if it does not coincide (step S3: NO), it judges again whether the predetermined time has passed or not from such time that a disc was loaded (step S4).

And, the step S3 and the step S4 are carried out repeatedly, and if the frequency of the horizontal synchronization signal of the second synchronization circuit 12 coincides with 15.73 KHz in the step S3 (step S3: YES), since the DVD image signal is inputted from the signal processing part 5 to the second synchronization circuit 12, it judges that a reproduction signal of the DVD 20 was received from the player 2 side, and it judges that a disc, which is loaded on the player 2, is the DVD 20 (step S5). If it judges in this manner, it switches over the switches S2, S3 of the image signal switching part 10 as described above, and displays an image of the DVD 20 on the CRT 8, on the basis of the DVD image signal from the signal processing part 5, and outputs a sound of the DVD 20 from the speaker 7, on the basis of the DVD sound signal from the signal processing part 5.

On one hand, when the frequency of the horizontal synchronization signal of the second synchronization circuit 12 does not coincide with 15.73 KHz in the step S3 (step S3: NO), and the predetermined time has passed in the step S4 (step S4: YES), since the DVD image signal is not inputted from the signal processing part 5 to the second synchronization circuit 12, it judges that a reproduction signal of the CD 30 was received from the player 2 side, and it judges that a disc, which is loaded on the player 2, is the CD 30 (step S7). If it judges in this manner, it switches over the switches S1˜S3 of the image signal switching part 10 as described above, and displays an fixed image for CD on the CRT 8, on the basis of the fixed image signal for CD from the signal processing part 5, and outputs a sound of the CD 30 from the speaker 7, on the basis of the CDD sound signal from the signal processing part 5.

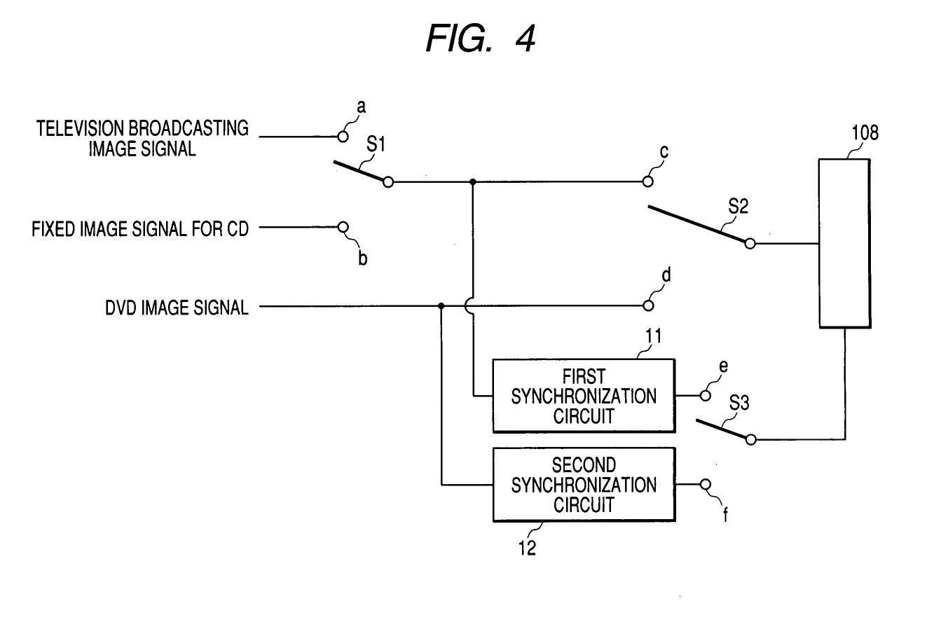

As described above, when an image of television broadcasting is displayed on the CRT 8, during a period of time from such time that the DVD 20 or the CD 30 is loaded on the player 2 until such time that the signal processing part 5 of the TV 1 receives a reproduction signal of the DVD 20 or the CD 30, since an image of television broadcasting changes momentarily, by having users view and hear television broadcasting, it is possible not to have them feel that waiting time until information of a disc can be viewed and heard is long. Also, since it eliminates such need that fixed image data for reading is processed at a disc player side and transmitted to the TV 1 as in the prior art, it is possible to ease a burden of the player 2 by reducing processes to be carried out by the player 2, and it is also possible to eliminate the fixed image transmission port P5 as shown in FIG. 4 and the fixed image data for reading itself, so that it becomes possible to keep cost low on an entire integration type receiving apparatus 100.

Also, when it was judged that a reproduction signal of the DVD 20 or the CD 30 was received, if an image of television broadcasting, which is displayed on the CRT 8, is switched to an image of the DVD 20 or a fixed image for CD, it is possible to have users recognized promptly that the DVD 20 or the CD 30 can be viewed and heard, and to have them enjoy those after that. Also, when it is judged that a reproduction signal of a disc is a reproduction signal of the DVD 20 or a reproduction signal of the CD 30 at the TV 1, i.e., when it is judged that a loaded disc is the DVD 20 or the CD 30, since it eliminates such need that a judgment of a disc is carried out at the player 2 side and its result is informed to the TV 1 side as in the prior art, it is possible to ease a burden of the player 2 more, by reducing processes to be carried out by the player 2, and it is possible to eliminate the disc information transmission port P2 as shown in FIG. 4, so that it becomes possible to keep cost further low on an entire integration type receiving apparatus 100.

Also, by providing the second synchronization circuit separately from the first synchronization circuit, it can be easily judged that the signal processing part 5 received a reproduction signal of the DVD 20 or received a reproduction signal of the CD 30 from the player 2 side, during a such period of time that an image of television broadcasting is displayed on the CRT 8. In addition, as in the prior art shown in FIG. 4, by providing two ports P3, P4 of the DVD reproduction signal transmission port P3, and the CD reproduction signal transmission port P4 and detecting presence or absence of transmission of a signal from respective ports P3, P4, it is also possible to judge a received reproduction signal of a disc at the TV side 1, but when the second synchronization circuit was disposed to judge a received reproduction signal of a disc as described above, it eliminates such need that ports for transmitting a reproduction signal of the DVD 20 and a reproduction signal of the CD 30 are provided separately, and they are united as one port Pb, and therefore, it becomes possible to keep cost further low on an entire integration type receiving apparatus 100, by reducing the number of ports between the player 2 and the TV 1.

Furthermore, in the integration type receiving apparatus 100 on which the player 2, which is capable of reproducing the DVD 20 or the CD 30, was mounted, since waiting time from such time that the DVD 20 or the CD 30 was loaded on the player 2 until such time the DVD 20 or the CD 30 can be viewed and heard is long, like approximately 10˜12 seconds, to apply this invention to an integration type receiving apparatus on which a player was mounted as described above is of great significance.

In the above-described embodiments, cited is such a case that the DVD 20 is used as an image disc, and the audio CD 30 is used as a sound disc, but this invention is not limited only to this, and other than this, as an image disc, such a disc as a Video CD and a blue laser disc may be used, and also, as a sound disc, a CD-R and a non-audio CD may be used.

Also, in the embodiment of FIG. 4, cited is such a case that, when a horizontal synchronization signal of the second synchronization circuit 12 remains not to coincide with 15.73 KHz and the predetermined time has passed, it is judged that a reproduction signal of the CD 30, but not of the DVD 20, was received, but this invention is not limited only to this. Other than this, it may be configured in such a manner that, for example, when a sound signal was inputted to the sound amplifier 6, if the horizontal synchronization signal of the second synchronization signal does not coincide with 15.73 KHz, it is judged that a reproduction signal of the CD 30, but not of the DVD 20, was received.

Further, the television receiver or display means is not limited to the one which includes CRT 8. As shown in FIG. 4, a liquid crystal display module 108 or a plasma display may be used.

According to this invention, by displaying an image of television broadcasting on display means, during a period of time from such time that a disc was loaded on a disc player until such time that a television receiver receives a reproduction signal of a disc, it is possible not to have users feel that waiting time until information of a disc can be viewed and heard is long, by having them view and hear television broadcasting.

1. A disc player integration type television receiver in which a disc player that reproduces data from any one of a DVD on which images are recorded and a CD on which sounds are recorded and a television receiver equipped with a CRT that displays the images of the DVD on the basis of a signal reproduced by the disc player and a speaker that outputs the sounds of the CD are integrated, the disc player integration type television receiver comprising:
a memory in which a fixed image, which does not change, is stored;
a first synchronization circuit that generates a synchronization signal for displaying images of television broadcasting received by an antenna or the fixed image on the CRT;
a second synchronization circuit that generates a synchronization signal for displaying the images of the DVD on the CRT;
a switch that switches over to display any one of the images of television broadcasting, the fixed image and the images of the DVD on the CRT; and
a microcomputer that controls the switch;
wherein the microcomputer switches over the switch to display the images of television broadcasting when the DVD or the CD is loaded on the disc player, and then judges whether a frequency of a horizontal synchronization signal generated by the second synchronization circuit coincides with a predetermined value or not, and if it coincides with the predetermined value, judges that a reproduction signal of the DVD is received and switches over the switch to display the images of the DVD on the CRT, and if it does not coincide with the predetermined value, judges that a reproduction signal of the CD is received and switches over the switch to display the fixed image on the CRT.

2. A disc player integration type television receiver in which a disc player that reproduces data from any one of an image disc on which images are recorded and a sound disc on which sounds are recorded and a television receiver equipped with display means that displays the images of the image disc on the basis of a signal reproduced by the disc player and sound output means that outputs the sounds of the sound disc are integrated;
wherein the television receiver displays images of television broadcasting received by an antenna on the display mean, during a period from such time that the image disc or the sound disc is loaded on the disc player until such time that a reproduction signal of the loaded disc is received.

3. The disc player integration type television receiver as claimed in claim 2, comprising:
storage means in which a fixed image, which does not change, is stored;
switching means that switches over to display any one of the images of television broadcasting, the fixed image and the images of the image disc on the display means; and
control means that controls the switching means;
wherein the control means switches over the switching means to display the images of television broadcasting when the image disc or the sound disc is loaded on the disc player, and then judges which one of a reproduction signal of the image disc and a reproduction signal of the sound disc is received, and if it judges that the reproduction signal of the image disc is received, switches over the switching means to display the images of the image disc on the display means, and if it judges that the reproduction signal of the sound disc is received switches over the switching means to display the fixed image on the display means.

4. The disc player integration type television receiver as claimed in claim 3, wherein the television receiver is equipped with a first synchronization circuit that generates a synchronization signal for displaying the images of television broadcasting or the fixed image on the display means, and a second synchronization circuit that generates a synchronization signal for displaying the images of the image disc on the display means; and
wherein the control means judges whether a frequency of a synchronization signal generated by the second synchronization circuit coincides with a predetermined value or not, and if it coincides with the predetermined value, judges that a reproduction signal of the image disc is received, and if it does not coincide with the predetermined value, judges that a reproduction signal of the sound disc is received.

5. A disc player integration type television receiver in which a disc player that reproduces data from any one of an image disc on which images are recorded and a sound disc on which sounds are recorded and a television receiver equipped with a display device that displays the images of the image disc on the basis of a signal reproduced by the disc player and a sound output device that outputs the sounds of the sound disc are integrated;
wherein the television receiver displays images of television broadcasting received by an antenna on the display device, during a period from such time that the image disc or the sound disc is loaded on the disc player until such time that a reproduction signal of the loaded disc is received.

6. The disc player integration type television receiver as claimed in claim 5, comprising:
a storage device in which a fixed image, which does not change, is stored;
a switching device that switches over to display any one of the images of television broadcasting, the fixed image and the images of the image disc on the display device; and
a control device that controls the switching device;
wherein the control device switches over the switching device to display the images of television broadcasting when the image disc or the sound disc is loaded on the disc player, and then judges which one of a reproduction signal of the image disc and a reproduction signal of the sound disc is received, and if it judges that the reproduction signal of the image disc is received, switches over the switching device to display the images of the image disc on the display device, and if it judges that the reproduction signal of the sound disc is received, switches over the switching device to display the fixed image on the display device.

7. The disc player integration type television receiver as claimed in claim 6, wherein the television receiver is equipped with a first synchronization circuit that generates a synchronization signal for displaying the images of television broadcasting or the fixed image on the display device, and a second synchronization circuit that generates a synchronization signal for displaying the images of the image disc on the display device; and
wherein the control device judges whether a frequency of a synchronization signal generated by the second synchronization circuit coincides with a predetermined value or not, and if it coincides with the predetermined value, judges that a reproduction signal of the image disc is received, and if it does not coincide with the predetermined value, judges that a reproduction signal of the sound disc is received.
